(19) United States
(12) Patent Application Publication
(10) Pub. No.: US 2009/0113516 A1
(43) Pub. Date: Apr. 30, 2009

(54) Setting Policy Based on Access Node Location

(75) Inventors: Loren Vorreiter, San Jose, CA (US); Martin Lord, Saratoga, CA (US); Jeffrey Pochop, Los Gatos, CA (US); Robert T. Martin, Cupertino, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: ARUBA NETWORKS, INC., Sunnyvale, CA (US)

(21) Appl. No.: 11/929,628

(22) Filed: Oct. 30, 2007

(51) Int. Cl. G06F 21/20

(52) U.S. Cl. 726/1

(57) ABSTRACT

Policy setting in an access node remotely located from a controller. A remote access node connects to a controller over a digital network such as the internet. Operating policy is established based on the location of the access node. In one embodiment, the location of the access node is determined through a GPS receiver associated with the node. In a second embodiment, the location of the access node is determined through its public IP address. Location information is used to establish policy at the access node, which may include aspects such as operating parameters, access controls, and availability of services through the controller.

### BACKGROUND OF THE INVENTION

The present invention relates to the operation of access nodes connected through a digital network to a central controller.

Businesses seek to meet the computing needs of a more mobile workforce while still maintaining security and controls over business resources. One means of providing access to resources in a controlled manner is a system such as that shown in FIG. 1. In this diagram, controller 110 inside an environment 100 connects 120 to the Internet 200 or other switched digital communications network. Controller 110 mediates access between the Internet 200 and other resources 130, 140, 150 which may include servers for mail and web services, file servers, and of course users accessing these services and the Internet via wired or wireless connections.

To support remote users such as remote computer 320, access node 300 connects 310 to the Internet 200 and also connects 330 to remote computer 320. The connection 310 between access node 300 and the internet 200 may be via wired or wireless means, using methods known to the art including but not limited to Ethernet, cable or DSL modems, or wireless connections including but not limited to 802.11, WiMAX, or EDGE. Similarly the connection 330 between access node 300 and remote computer 320 may be wired or wireless using technologies known to the art including but not limited to wired connections such as Ethernet, or wireless connections such as 802.11.

In operation, access node 300 has the IP address of its controller 110 and security credentials to authenticate to controller 110. When access node 300 starts up, it establishes a connection such as a GRE tunnel to controller 110, routing all communications from remote computer 320 through controller 110 This allows computer 320 to have access to resources such as servers and services 130 140 inside the environment 100. It also allows corporate policies on access to be applied.

Mobile users are increasingly mobile. The user of access node 300 and remote computer 320 may normally be based in Santa Rosa, Calif., but may occasionally work from other locations such as Toronto, Brussels, Topeka, or Melbourne. Access node 300, since it establishes a connection based on the IP address of controller 110 is able to provide access wherever suitable power and internet connectivity 310 are available. The life of the user of computer 320 is greatly simplified; wherever they go, access node 300 provides them the same access, security, and protection as if they were in the office.

Unfortunately, other concerns and policies enter the picture. Regulatory concerns, for example, may restrict access to systems and/or data. Certain classes of data may not legally be exported outside of specific regions or countries. A business may wish to limit access based on the location of the user. As an example, if access node 300 supports wireless 802.11 access for connection 330, the frequencies and power levels which may be used legally differ in different countries.

What is needed is a way to set policy based on an access node's location,

### BRIEF DESCRIPTION OF THE DRAWINGS

The invention may be best understood by referring to the following description and accompanying drawings that are used to illustrate embodiments of the invention in which:

FIG. 1 shows a block diagram of a network,

FIG. 2 shows a block diagram of an access node, and

FIG. 3 shows an access node and a block diagram of a controller.

### DETAILED DESCRIPTION

Embodiments of the invention relate to setting policy based on the location of a access node connected to a controller over a digital network. Operating policy is established based on the location of the access node, and imposed on the access node and/or services delivered to the access node through the controller. In one embodiment, the location of the access node is determined through a GPS receiver associated with the node, receiving and processing signals from the constellation of GPS satellites and deriving location data. In a second embodiment, the location of the access node is determined through the network connection and the public IP address of the access node. This IP address may be verified by the controller, for example using Traceroute data. Location information is translated via a database to retrieve policy information, which may include operating aspects at the access node such as operating parameters, access controls and the like. Policy imposed at the controller may include aspects such as access lists and permissions determining what resources are available to the remotely located access node.

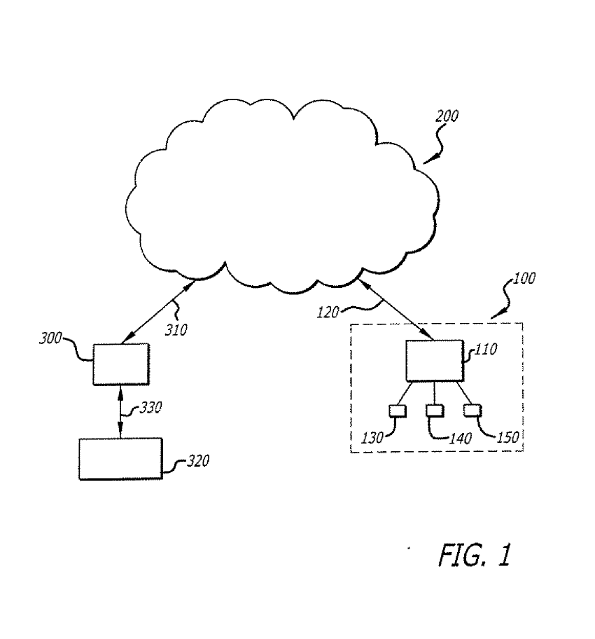

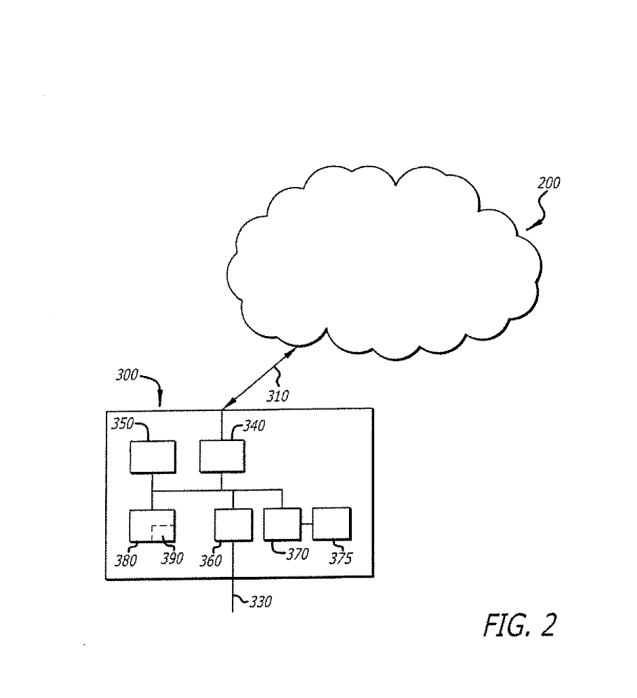

According to one embodiment of the invention and as shown in FIG. 2, access node 300 communicates 310 with the Internet 200 or other switched digital communications network Access node 300 operates under control of CPU 350, which connects to memory hierarchy 380, first network interface 340, second network interface 360, GPS receiver 370, and GPS antenna 375. In one embodiment, CPU 350 is a MIPS64 processor available from companies such as Cavium Networks. Other processors, such as those from Intel, AMD, ARM, or VIA may be used. First network interface 340 may be a wired or wireless Ethernet interface, a cable or DSL modem, or other wireless interface such as WiMAX or EDGE. Second network interface 360 which is used to communicate 330 to computer 320 of FIG. 1. may be a wired or wireless Ethernet interface, or other interface known to the art such as Bluetooth or USB.

In accordance with one embodiment of the invention, access node 300 also includes GPS receiver 370 and GPS antenna 375. Suitable GPS receivers are available from companies such as SiRF Technology and Trimble Navigation Limited. While shown as integrated into access node 300, it may be desirable to have GPS antenna 375 or both GPS antenna 375 and GPS receiver 370 mounted outside access node 300, as acquisition of GPS satellite signals requires an unobstructed view of the sky by antenna 375. In such an embodiment, GPS receiver 370 may obtain power and communicate with access node 300 via a USB connection; GPS receivers with integrated antennas and USB interfaces are available from a number of sources including SiRF Technologies, Trimble Navigation Limited, and Garmin Ltd. GPS receiver 370 may also communicate with node 300 via a short-range RF connection such as Bluetooth or Zigbee.

Access node 300 also contains memory hierarchy 380, which as understood by the art includes a permanent memory such as ROM, EPROM or Flash for system startup, fast read-write memory such as DRAM, and bulk memory such as compact flash or hard disk. In one embodiment of the invention, access node 300 runs under the Linux operating system, with additional tasks to provide remote access capabilities

In operation according to an embodiment of the invention, access node 300 may be configured to require location information one time only, or periodically. When location information is required, access node 300 uses GPS receiver 370 with antenna 375 to determine its location using the constellation of GPS satellites. This location information is recorded in memory 380. While memory 380 may contain a local database 390 for translating GPS coordinates to location information such as a two or three character country code based on the ISO 3166 standard for use by access node 300, this location information is also transmitted to controller 110. This location information is preferably transmitted to controller 110 as GPS coordinates, although it can also be transmitted in an abbreviated form, such as a two or three character country code. If GPS coordinates or the equivalent are transmitted to controller 110, then controller 110 must perform a similar database lookup to convert this information to country code information. Such databases are known to the art, and are commercially available.

Given the country code representing the location of the access node, both access node 300 and controller 110 use this information to set policy.

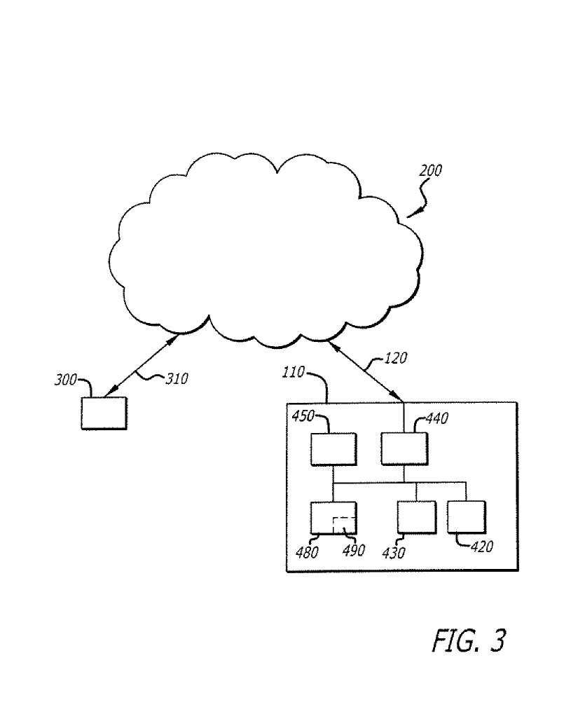

In a second embodiment of the invention, and as shown in FIG. 3, the location of access node 300 is derived from its public IP address. Controller 110 connects 120 to internet 200. Note that additional systems such as firewalls, switches, routers, and the like may be present between controller 110 and its internet gateway. Controller 110 typically has network interface 440, and is run by CPU 450 connected to memory hierarchy 480. Controller 110 may have additional network interfaces 420, 430 for connecting to other network services, workstations, and the like. In one embodiment, CPU 450 is a MIPS64 class processor such as those available from Cavium Networks or Raza, although processors of other architectures, such as those from Intel, AMD, ARM, IBM, Freescale, and the like may also be used. Similar to access node 300, memory hierarchy 480 typically comprises a small permanent memory such as ROM, EPROM, EEPROM or Flash, used for system startup, a larger high-speed memory such as DRAM, and bulk storage such as Compact Flash or hard disk. Controller 110 typically operates under the control of a Linux operating system, although other operating systems may be used.

When a TCP/IP connection is made to controller 110, the IP address of the device requesting the connection is available to controller 110. This IP address under the IPV4 protocols is traditionally represented in dot quad fashion, such as 221.208.208.92, and may be treated as an unsigned 32-bit quantity. While examples are given in terms of IPV4, the invention is equally applicable to IPV6 protocols, where IPV6 addresses are 128 bits as compared to the 32 bit addresses used in IPV4. IPV6 addresses are typically written as eight groups of four hexadecimal digits separated by colons, such as fe80:0000:0000:0000:0219:e3ff:fe38:1978.

Controller 110 looks up the IP address of access node 300 and translates that IP address to a country code using database 490 stored in memory hierarchy 480. Free and commercial databases are available on the Internet for resolving ranges of IP addresses to country codes, as are commercial services. A typical database, such as the one offered at http://ip-to-country.webhosting.info/ consists of a sequence of records, each record containing lower and upper bound values for a range of IP addresses, and the country code associated with that range of addresses. Such databases are small, typically under 6 megabytes in size.

Once the IP address of access node 300 has been translated to a country code, this country code information is transmitted to access node 300, and both access node 300 and controller 300 use this information to set policy. IP address information, and location information may be verified to a certain degree by collecting and analyzing path information for example using Traceroute or similar protocols. Such Traceroute information may be useful, for example, if the remote node is behind one or more routers performing network address translation (NAT), or virtual private networks (VPN) Traceroute and similar tools return a list of routers (and their IP addresses) a series of packets traversed to travel to a destination, as an example, from controller 110 to access node 300. Controller 110 may run this list, translating each IP address to its country, to validate the address of node 300.

Aspects of policy, particularly policy which affects the operation of access node 300, may be stored in a policy database 390 within access node 300, or they may be stored in a policy database 490 in controller 110. Policy may also be stored both locally within access node 300, and with controller 110. It may also be desirable to store the policy database external to controller 110, such as on a separate file server available to controller 110.

An example of policy set at access node 300 is the configuration of wireless connections. Channel availability and maximum power levels for 802.11 channels vary by country. As an example, a portion of the 5 GHZ spectrum is available for 802.11 use in the United States, but not in some other countries. Channel availability in the 2.4 GHz spectrum for 802.11 use, and maximum transmit power level, also varies from country to country. In such a case, the location of access node 300 is used to establish the wireless configuration for wireless network interface 360 of FIG. 2.

For policy settings such as those with keen regulatory aspects, such as wireless operation, it is useful to define a default state for access node 300, in which that aspect of access node operation is restricted until and unless location-based policy is provided. In the case of wireless operation, it may be useful to have this default state as prohibiting or greatly restricting wireless access until location-based policy may be established.

An example of policy set at controller 110 involves access to services. Corporate data protection policies, for example, may restrict access to certain classes of information to users within a certain country. If an access node 300 identifies itself as being in a different country, controller 110 would impose access rules prohibiting access to such restricted databases. Other examples include but are not limited to resources such as DNS servers, mail servers, print servers, and the like.

Configuration of split tunnel capabilities at node 300 are an additional example of policy, determining what sets of requests will be tunneled back to controller 110, and which will be routed to the local internet.

It may be desirable for controller 110 to be able to update the databases, policy, and default policy settings stored at node 300. Such updates may be delivered using the same mechanisms used to update other software stored in memory hierarchy 408. In one embodiment, such updates are cryptographically signed, and the signatures verified at node 300, to detect possible transmission errors, and to provide some protection against meddlers.

While the invention has been described in terms of several embodiments, the invention should not be limited to only those embodiments described, but can be practiced with modification and alteration within the spirit and scope of the appended claims. The description is this to be regarded as illustrative rather than limiting.

What is claimed is:

1. A method of setting policy in an access node remotely connected to a controller over a digital network comprising:
establishing a location code for the node,
translating the location code to a location,
retrieving policy based on the location, and
establishing policy for the node based on the location.

2. The method of claim 1 where the location code is the GPS location of the node.

3. The method of claim 2 where the location code is calculated by a GPS receiver associated with the node.

4. The method of claim 3 where the GPS receiver is built into the node.

5. The method of claim 3 where a GPS receiver is external to the node and connected to the node.

6. The method of claim 1 where the location code is the public IP address associated with the node.

7. The method of claim 1 where the step of translating the location code to a location is performed in the node.

8. The method of claim 1 where the step of translating the location code to a location is performed by the controller.

9. The method of claim 1 where policy is stored in the node.

10. The method of claim 1 where policy is retrieved from the controller.

11. The method of claim 1 where policy is stored in the node and retrieved from the controller.

12. The method of claim 1 where default policy is stored in the node.

13. The method of claim 1 where policy stored in the node may be updated by the controller.

14. The method of claim 1 where the policy controls operation of a wireless interface in the node.

15. The method of claim 14 where the policy controls the channels of operation of a wireless interface in the node.

16. The method of claim 14 where the policy controls transmit power levels of a wireless interface in the node.

17. The method of claim 1 where the policy controls operation of a split tunnel in the node.

18. The method of claim 1 where the policy controls access to resources through the controller.
